(19) United States
(12) Patent Application Publication
(10) Pub. No.: US 2008/0290035 A1
(43) Pub. Date: Nov. 27, 2008

(54) Method and Sorbant for Removing Contaminates From Water

(76) Inventors: Frederick W. Vance, Freeland, MI (US); Robert E. Reim, Midland, MI (US)

Correspondence Address: The Dow Chemical Company, Intellectual Property Section, P.O. Box 1967, Midland, MI, 48641-1967, US

(21) Appl. No.: 12/097,281

(22) PCT Filed: Feb. 2, 2006
(86) PCT No.: PCT/US2006/004028

§ 371 Date: Jun. 13, 2008

(51) Int. Cl. C02F 1/28; B01J 20/06

(52) U.S. Cl. 210/681; 502/400

(57) ABSTRACT

A method for removing dissolved contaminants, such as arsenate, from water by the step of contacting a sorbant with the water, the sorbant comprising more than ten weight percent of an oxide of titanium and more than one tenth weight percent of a sulfate salt, such as calcium sulfate, having a solubility in water at room temperature of less than 0.5 grams per liter of water, wherein the oxide of titanium is primarily titanium dioxide.

### BACKGROUND OF THE INVENTION

The instant invention is in the field of methods and sorbants for removing dissolved contaminates from water and more specifically by the use of a sorbant comprising an oxide of titanium and a sulfate salt or a base.

U.S. Pat. No. 6,919,029, herein fully incorporated by reference, describes a method and sorbant for removing dissolved contaminates from water, such as arsenic compounds, using, among other things, a sorbant comprising an oxide of titanium. The method and sorbant of the '029 patent work well but the treated water is acidic. It would be an advance in this art if a sorbant were discovered for removing dissolved contaminants from water that was effective like the sorbant of the '029 patent but which did not excessively lower the pH of the treated water.

### SUMMARY OF THE INVENTION

The instant invention provides a method and sorbant for removing dissolved contaminants from water which are effective like the sorbant of the '029 patent but which do not excessively lower the pH of the treated water. In the instant invention the sorbant (like the sorbant of the '029 patent) comprises an oxide of titanium and (unlike the sorbant of the '029 patent) a sulfate salt or a base.

More specifically, the instant invention in one embodiment is a method for removing dissolved contaminants from water, comprising the step of contacting a sorbant with the water, the sorbant comprising more than ten weight percent of an oxide of titanium and more than one tenth weight percent of a sulfate salt having a solubility in water at room temperature of less than 0.5 grams per liter of water, wherein the oxide of titanium is primarily titanium dioxide.

In another embodiment, the instant invention is a method for removing dissolved contaminants from water, comprising the step of contacting a sorbant with the water, the sorbant comprising more than ten weight percent of an oxide of titanium and more than one tenth weight percent of a base, the base having a solubility in water at room temperature of less than 0.5 grams per liter of water, wherein the oxide of titanium oxide is primarily titanium dioxide.

In another embodiment, the instant invention is a sorbant for removing dissolved contaminants from water, the sorbant comprising more than ten weight percent of an oxide of titanium and more than one tenth weight percent of a sulfate salt having a solubility in water at room temperature of less than 0.5 grams per liter of water, wherein the oxide of titanium is primarily titanium dioxide.

### DETAILED DESCRIPTION

The instant invention is a method and sorbant for removing dissolved contaminants from water. The dissolved contaminates comprise the same contaminates as listed in the '029 patent and can further include, without limitation thereto, dissolved lead, vanadium, selenium, copper, nickel, mercury and chromium. The method and sorbant of the instant invention are especially effective for removing dissolved arsenic compounds from water.

The sorbant of the instant invention in one embodiment comprises more than ten weight percent of an oxide of titanium and more than one tenth weight percent of a sulfate salt having a solubility in water at room temperature of less than 0.5 grams per liter of water, wherein the oxide of titanium is primarily titanium dioxide. Preferably, more than 80% by weight of the sorbant has a particle size in the range of from 10 to 60 US mesh. More preferably, more than 80% by weight of the sorbant has a particle size in the range of from 16 to 60 US mesh. Even more preferably, more than 80% by weight of the sorbant has a particle size in the range of from 25 to 45 US mesh. However, it should be understood that for some applications smaller sized sorbant can be used such as a sorbant wherein more than 80% by weight of the sorbant has a particle size in the range of from 100 to 400 US mesh or from 200 to 325 US mesh.

The sorbant of the instant invention preferably comprises more than 0.5 percent by weight of the sulfate salt. The sorbant of the instant invention more preferably comprises more than 2 percent by weight of the sulfate salt. The sorbant of the instant invention even more preferably comprises more than 5 percent by weight of the sulfate salt. The sorbant of the instant invention yet even more preferably comprises more than 10 percent by weight of the sulfate salt. Preferably, the sulfate salt is a calcium sulfate salt. However, when the sulfate salt is a calcium sulfate salt, then preferably the sorbant comprises less than 5% calcium on an elemental analysis basis by weight. The preferred chemical analysis method used to determine the sulfate salt and the titanium oxide form (for example, calcium sulfate can be present in the gypsum and/or the bassenite form while titanium dioxide can be present in the anatase or rutile form) and concentration of the sorbant of the instant invention is X-ray diffraction spectroscopy. The sulfur concentration of the sorbant of the instant invention can be determined by X-ray fluorescence analysis. Analysis of the sorbant of the instant invention in terms of elemental titanium can be performed by neutron activation analysis or X-ray flourescence.

Preferably, the oxide of titanium of the sorbant of the instant invention is produced by the well known sulfate process. Preferably, the sorbant of the instant invention comprises more than twenty weight percent titanium on an elemental analysis basis. More preferably, the sorbant of the instant invention comprises more than forty weight percent titanium on an elemental analysis basis.

Alternatively, the sorbant for use in the instant invention can comprise more than ten weight percent of an oxide of titanium and more than one tenth weight percent of a base, the base having a solubility in water at room temperature of less than 0.5 grams per liter of water, wherein the oxide of titanium oxide is primarily titanium dioxide. Any base can be used which meets the above mentioned solubility limit, including hydroxide ion form ion-exchange resin.

The method of the instant invention comprises the step of contacting a sorbant of the instant invention with the water. Preferably, the water is flowed through a bed of the sorbant.

The sorbant of the instant invention is preferably made by adding lime and water to uncalcined sulfate process titanium dioxide to form a paste which is then extruded through a die to form rod-like granules which are dried and then ground (and optionally sieved) to produce a particle size distribution appropriate for a specific application. The use of such lime in the instant invention has the additional benefit of producing a sorbant having higher mechanical strength (less attrition) and a lower bulk density than the sorbants of the '029 patent.

### COMPARATIVE EXAMPLE 1

1.06 kilograms of uncalcined titanium oxide powder (having an anatase titanium dioxide concentration of about 80% by weight) is mixed with 3 kilograms of water and then let stand overnight. The mixture was then dried at 80 degrees Celcius tor at least 4 hours or until the % moisture was less than 10% as measured by a laboratory moisture balance. 0.97 kilograms of the resulting solid is then ground to a fine powder and mixed with 89 grams of Ludox brand binding agent (30 wt % colloidal SiO₂ in water) and 430 grams of water and mulled to produce a pug extruded through a 3 hole ( 1/16 inch diameter) extruder. The extrudates from the extruder are dried at 80 degrees Celsius overnight and then ground and sieved to produce Sorbant #1 having a particle size of from 16 to 60 US mesh. The packed bed density of the material (Sorbant #1) is 0.91 grams per milliliter (ASTM test method B-527). The wet attrition was measured by placing 20 g each of a 20×30 and 30×40 mesh sample in a wide mouth glass jar with 80 ml of water. The jar is placed on a roller and rolled at 85 rpm for a period of 30 minutes. The contents of the jar are poured through a 60 mesh screen and the screen is dried in air at 80° C. for 6 to 16 hours. After accounting for moisture lost or gained in the procedure, the % attrition is calculated from the amount retained on the screen relative to that originally placed in the jar. The wet attrition of Sorbant #1 is 17%.

Tap water having a pH of about 7.8 is flowed through a one half liter filter cartridge packed with Sorbant #1. The initial pH of the treated water is about 2.3. The pH of the treated water after 50 liters of water have been treated is about 3.2. The pH of the treated water after 100 liters of water have been treated is about 3.6. The pH of the treated water after 150 liters of water have been treated is about 5.0.

### EXAMPLE 1

1.08 kilograms of uncalcined titanium oxide powder (having an anatase titanium dioxide concentration of about 80% by weight) is mixed with 36 grams of Ca(OH)₂, 3 kilograms of water and then let stand overnight. The mixture was then dried at 80 degrees Celcius for at least 4 hours or until the % moisture was less than 10% as measured by a laboratory moisture balance. 1.04 kilograms of the resulting solid was then ground to a fine powder and mixed with 94 grams of Ludox brand binding agent (30 wt % colloidal SiO₂ in water) and 490 grams of water and mulled to produce a pug extruded through a 3 hole ( 1/16 inch diameter) extruder. The extrudates from the extruder are dried at 80 degrees Celsius overnight and then ground and sieved to produce Sorbant #2 having a particle size of from 16 to 60 US mesh. The packed bed density of Sorbart #2 is 0.84 grams per milliliter. The wet attrition (described in COMPARITIVE EXAMPLE 1) of the material is 6%.

Tap water having a pH of about 7.8 is flowed through a one half liter filter cartridge packed with Sorbant #2. The initial pH of the treated water is about 6.7. The pH of the treated water after 50 liters of water have been treated is about 6.2. The pH of the treated water after 100 liters of water have been treated is about 6.3. The pH of the treated water after 150 liters of water have been treated is about 6.5.

### COMPARATIVE EXAMPLE 2

1.0 kilograms of uncalcined titanium oxide powder (predominately anatase titanium dioxide, having an elemental titanium analysis of about 53% by weight, an elemental sulfur analysis of about 2.2% by weight, and an elemental calcium analysis of about 0.01% by weight, available commercially as Grade G-3 uncalcined ultra fine TiO₂ from Millennium Chemicals, Hunt Valley, Md.) is mixed with 100 grams of Ludox brand binding agent (30 wt % colloidal SiO₂ in water) and water and mulled to produce a pug extruded through a 3 hole ( 1/16 inch diameter) extruder. The extrudates from the extruder are dried at 80 degrees Celsius overnight and then ground and sieved to produce Sorbant #3 having a particle size of from 16 to 60 US mesh.

Water containing 300 parts per billion of arsenate (prepared according to NSF/ANSI standard 53) having a pH of about 7.5 is flowed through a 0.45 inch inside diameter, 4 inch long column packed with Sorbant #3 at a flow rate controlled to give an empty bed contact time (EBCT) of 120 seconds. The treated water is sampled periodically and analyzed for arsenic. The initial arsenic concentration of the treated water is below the detection limit of about 1 part per billion. The initial pH of the treated water is 2.5 (and reaches a pH of 7 after 830 bed volumes of water have been treated). The arsenic concentration of the effluent water is about 1 part per billion after 4,000 bed volumes of water have been treated. The arsenic concentration of the effluent water is about 10 part per billion after 6,000 bed volumes of water have been treated.

### EXAMPLE 2

1.0 kilograms of uncalcined titanium oxide powder treated with lime (predominately anatase titanium dioxide, having an elemental titanium analysis of about 52% by weight, an elemental sulfur analysis of about 1.9% by weight, and an (elemental calcium analysis of about 2.1% by weight, available commercially as Grade G-2 uncalcined ultra fine TiO₂ from Millennium Chemicals, Hunt Valley, Md.) is mixed with 100 grams of Ludox brand binding agent (30 wt % colloidal SiO₂ in water) and water and mulled to produce a pug extruded through a 3 hole ( 1/16 inch diameter) extruder. The extrudates from the extruder are dried at 80 degrees Celsius overnight and then ground and sieved to produce Sorbant #4 having a particle size of from 16 to 60 US mesh.

Water containing 300 parts per billion of arsenate (prepared according to NSF/ANSI standard 53) having a pH of about 7.5 is flowed through a 0.45 inch inside diameter, 4 inch long column packed with Sorbant #4 at a flow rate controlled to give an empty bed contact time (EBCT) of 120 seconds. The treated water is sampled periodically and analyzed for arsenic. The initial arsenic concentration of the treated water is below the detection limit of about 1 part per billion. The initial pH of the treated water is 5 (and reaches a pH of 7 after 120 bed volumes of water have been treated). The arsenic concentration of the effluent water is about 1 part per billion after 4,000 bed volumes of water have been treated. The arsenic concentration of the effluent water is about 10 part per billion after 7,500 bed volumes of water have been treated.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

1. A method for removing dissolved contaminants from water, comprising the step of contacting a sorbant with the water, the sorbant comprising more than twenty weight percent titanium on an elemental analysis basis and more than 2 weight percent of a sulfate salt having a solubility in water at room temperature of less than 0.5 grams per liter of water, wherein the oxide of titanium is primarily titanium dioxide.

2-3. (canceled)

4. The method of claim 1, wherein the sorbant comprises more than 5 percent by weight of the sulfate salt.

5. The method of claim 1, wherein the sorbant comprises more than 10 percent by weight of the sulfate salt.

6. The method of claim 2, wherein the sulfate salt is a calcium sulfate salt.

7. The method of claim 6, wherein the sorbant comprises less than 5% calcium on an elemental analysis basis by weight.

8-18. (canceled)

19. The method of claim 1, wherein the sorbant comprises more than forty weight percent titanium on an elemental analysis basis, more than one weight percent sulfur on an elemental analysis basis, and less than five weight percent calcium on an elemental analysis basis.

20. The method of claim 19, wherein the sorbant comprises more than two weight percent sulfur on an elemental analysis basis.

21-23. (canceled)

24. A sorbant comprising more than twenty weight percent titanium on an elemental analysis basis, and more than 2 weight percent of a sulfate salt having a solubility in water at room temperature of less than 0.5 grams per liter of water, wherein the oxide of titanium is primarily titanium dioxide.

25-29. (canceled)

30. The method of claim 1 wherein the sorbant is formed by adding lime and water to uncalcined titanium dioxide.

31. The method of claim 1 where the step of contacting the sorbant with water comprises flowing water through a bed of the sorbant.

32. The sorbant of claim 24 comprising more than 5 weight percent of the sulfate salt.

33. The sorbant of claim 24 comprising more than 10 weight percent of the sulfate salt.

34. The sorbant of claim 24 wherein the sulfate salt comprises calcium sulfate.

35. The sorbant of claim 24 comprising less than five weight percent calcium on an elemental analysis basis.

36. The sorbant of claim 24 comprising more than forty weight percent titanium on an elemental analysis basis, more than one weight percent sulfur on an elemental analysis basis, and less than five weight percent calcium on an elemental analysis basis.

37. The sorbant of claim 36 comprising more than two weight percent sulfur on an elemental analysis basis.
